(19) United States
(12) Patent Application Publication
(10) Pub. No.: US 2013/0072366 A1
(43) Pub. Date: Mar. 21, 2013

(54) COIL-TUBE CHUNK FOR A ROLL FEEDER

(71) Applicant: Steven Lai, Taichung City (TW)

(72) Inventor: Steven Lai, Taichung City (TW)

(21) Appl. No.: 13/235,453

(22) Filed: Sep. 18, 2011

(51) Int. Cl. F16C 13/00

(52) U.S. Cl. 492/47

(57) ABSTRACT

A coil-tube chunk for a roll feeder has at least one colleting device. Each of the at least one colleting device has a base and a chunk. The base has a mounting stand, a sharp-tooth mount and multiple screwing rods. The mounting stand is formed on and protrudes from the base. The sharp-tooth mount is formed on the base around the mounting stand. The screwing rods are respectively and securely mounted on the sharp-tooth mount. The chunk is mounted securely on the base and has a guiding face, multiple grooves and multiple engaging teeth. The guiding face is aslantly formed on an external surface of the chunk. The grooves are formed in the external surface and the guiding frace of the chunk at intervals. The engaging teeth are formed on the external surface and the guiding face of the chunk between the grooves.

### BACKGROUND OF THE INVENTION

1. Field of the Invention

The present invention relates to a coil-tube chunk, and more particularly to a coil-tube chunk for a roll feeder that can provide a preferred holding effect to a coil tube of the roll feeder.

2. Description of Related Art

With reference to FIG. 9, a conventional roll feeder 50 has a coil tube 54 and two rolling arms 51 set to face each other at an interval to hold the coil tube 54. The coil tube 54 may be a paper tube and has two ends, an internal surface and two operational metal rings. The metal rings are mounted on the internal surface of the coil tube 54 at the ends of the coil tube 54. Each rolling arm 51 has a lower end, an inner side, a driving head 52 and a coil-tube chunk 53. The driving head 52 is rotatably mounted on the inner side of the rolling arm 51 at the lower end of the rolling arm 51, is driven by a motor and has an inner end. The coil-tube chunk 53 is conic, is securely and concentrically mounted on the inner end of the driving head 52 and has a cone surface.

The coil-tube chunks 53 of the rolling arms 51 are used to hold the coil tube 54 on the roll feeder 50 by the cone surfaces of the coil-tube chunks 53 abutting against the internal surface or the metal rings of the coil tube 54 at the ends of the coil tube 54. When the coil-tube chunks 53 are rotated with the driving heads 52, the coil tube 54 is rotated with the coil-tube chunks 53 by the friction forces between the cone surfaces of the coil-tube chunks 53 and the internal surface of the coil tube 54. When the thickness of the coil tube 54 is thinning to reduce the structural strength of the coil tube 54, the ends of the coil tube 54 may be held open by the cone surfaces of the coil-tube chunks 53 and this is inconvenient in use. In addition, the damaged coil tube 54 cannot be reused in a next processing flow.

Furthermore, when the cone surfaces of the coil-tube chunks 53 abut against the metal rings of the coil tube 54 at the ends of the coil tube 54, the friction forces between the cone surfaces of the coil-tube chunks 53 and the metal rings of the coil tube 54 may be inadequate to enable the coil tube 54 to rotate with the coil-tube chunks 53 and this will influence the rotation of the coil tube 54 and limit the applicable styles and models of the coil tube 54.

The invention provides a coil-tube chunk for a roll feeder that mitigates or obviates the aforementioned problems.

### SUMMARY OF THE INVENTION

The main objective of the present invention is to provide a coil-tube chunk for a roll feeder that can provide a preferred holding effect to a coil tube of the roll feeder.

The coil-tube chunk for a roll feeder in accordance with the present invention has at least one colleting device. Each of the at least one colleting device has a base and a chunk. The base has a mounting stand, a sharp-tooth mount and multiple screwing rods. The mounting stand is formed on and protrudes from the base. The sharp-tooth mount is formed on the base around the mounting stand. The screwing rods are respectively and securely mounted on the sharp-tooth mount. The chunk is mounted securely on the base and has a guiding face, multiple grooves and multiple engaging teeth. The guiding face is aslantly formed on an external surface of the chunk. The grooves are formed in the external surface and the guiding face of the chunk at intervals. The engaging teeth are formed on the external surface and the guiding face of the chunk between the grooves.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a coil-tube chunk for a roll feeder in accordance with the present invention;

FIG. 2 is an exploded perspective view of the coil-tube chunk for a roll feeder in FIG. 1;

FIG. 3A is a side view in partial section of the coil-tube chunk for a roll feeder in FIG. 1;

FIG. 3B is an enlarged side view of the coil-tube chunk for a roll feeder in FIG. 3A;

FIG. 4 is an operational side view in partial section of the coil-tube chunk for a roll feeder in FIG. 1 for holding a coil tube;

FIG. 5 is an enlarged operational side view in partial section of the coil-tube chunk for a roll feeder in FIG. 1 for holding a coil tube;

FIG. 6 is a perspective view of a second embodiment of a coil-tube chunk for a roll feeder in accordance with the present invention;

FIG. 7 is an exploded perspective view of the coil-tube chunk for a roll feeder in FIG. 6;

FIG. 8A is an operational side view in partial section of the coil-tube chunk for a roll feeder in FIG. 1 for holding a coil tube;

FIG. 8B is an enlarged operational side view in partial section of the coil-tube chunk for a roll feeder in FIG. 8A for holding a coil tube; and

FIG. 9 is an operational side view of a coil-tube chunk for a roll feeder in accordance with the prior art.

### DETAILED DESCRIPTION OF THE PREFERRED EMBODIMENT

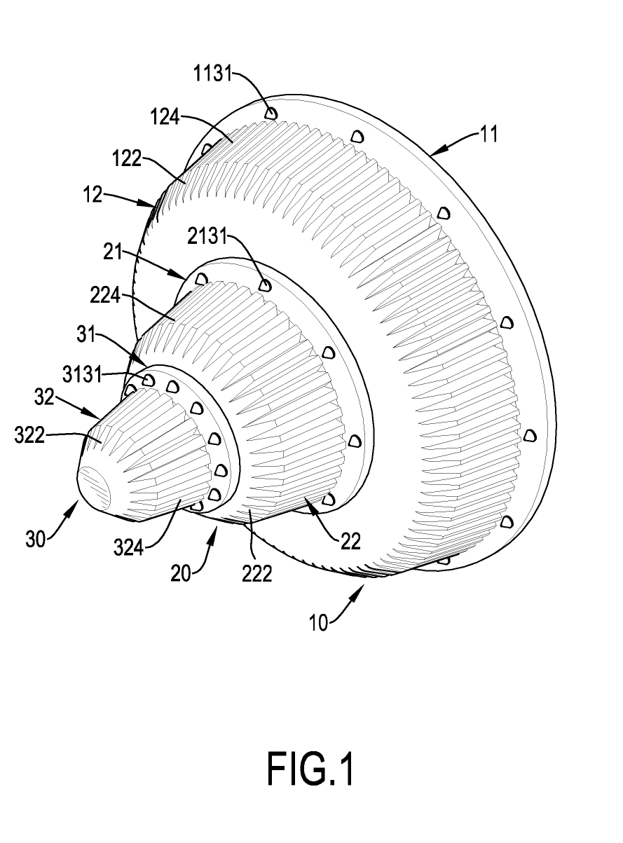

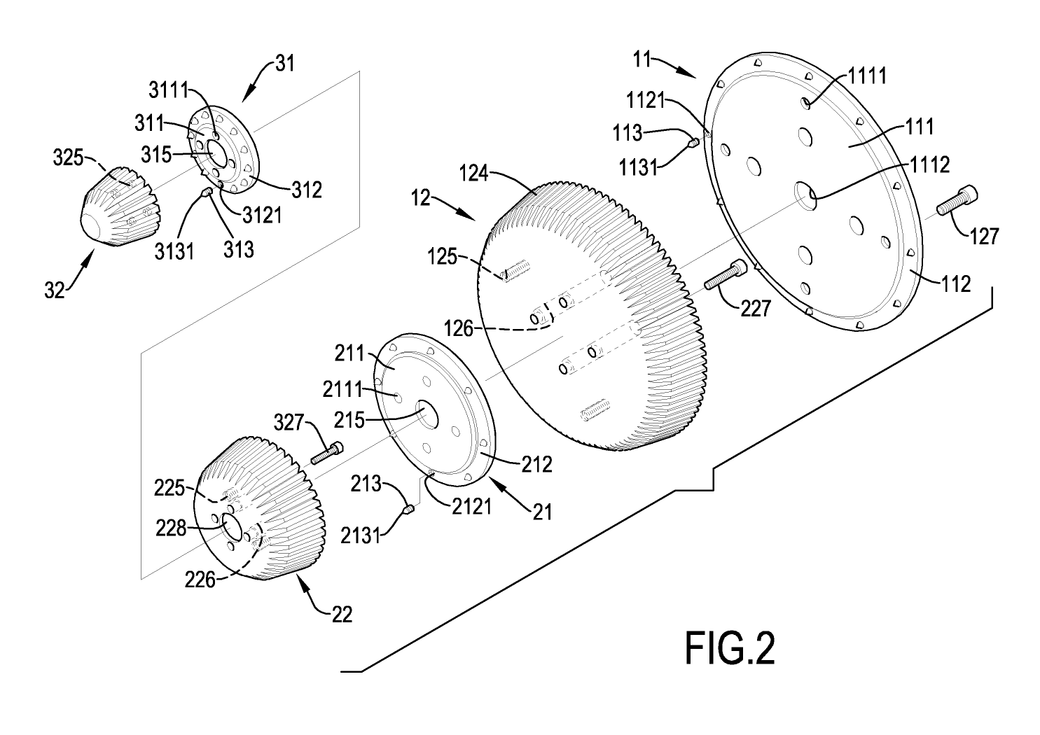

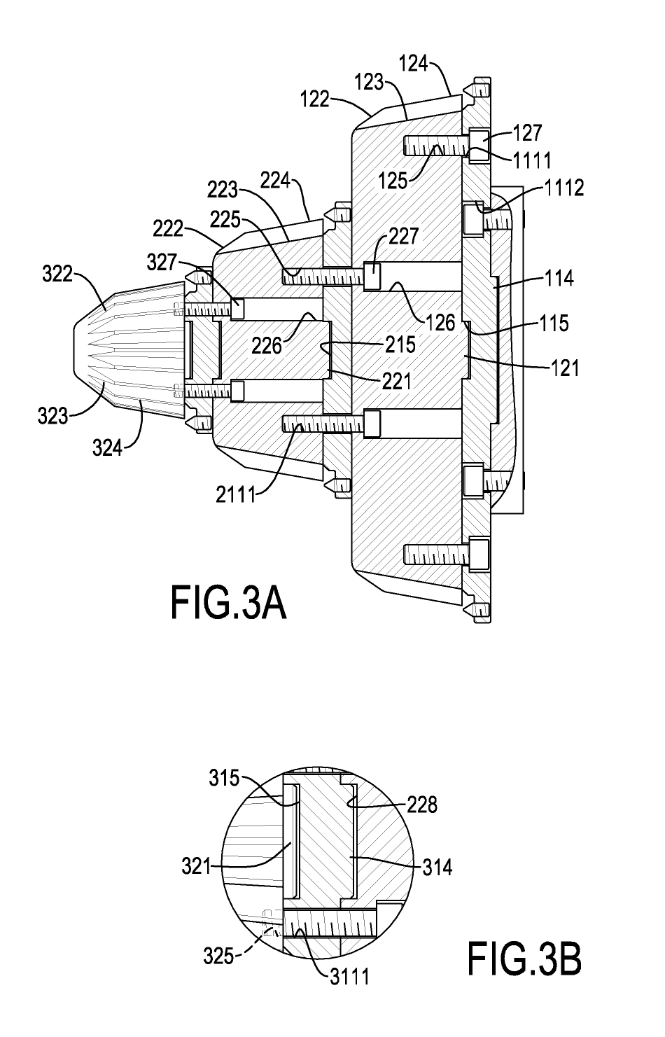

With reference to FIGS. 1, 2, 3A and 3B, a first embodiment of a coil-tube chunk for a coil tube 43 of a roll feeder 40 in accordance with the present invention comprises a rear colleting device 10, a middle colleting device 20 and a front colleting device 30. The colleting devices 10, 20, 30 are connected to each other concentrically and the diameters of the colleting devices 10, 20, 30 are in a reducing sequence from the rear colleting device 10 to the front colleting device 30.

The rear colleting device 10 has a base 11 and a chunk 12.

The base 11 is circular and has a front side, a mounting stand 111, a sharp-tooth mount 112, multiple screwing rods 113, a positioning protrusion 114 and an embedded slot 115. The mounting stand 111 is formed on and protrudes from the front side of the base 11 and has a center, a front side, a rear side, multiple bolt-holes 1111 and multiple connecting holes 1112. The bolt-holes 1111 are formed through the sides of the mounting stand 111 at intervals. The connecting holes 1112 are formed through the sides of the mounting stand 111 at intervals between the bolt-holes 1111 and the center of the mounting stand 111.

The sharp-tooth mount 112 is formed on the front side of the base 11 around the mounting stand 111 and has a front side and multiple screwed holes 1121. The screwed holes 1121 are formed in the front side of the sharp-tooth mount 112 at intervals around the mounting stand 111. The screwing rods 113 are respectively and securely mounted in the screwed holes 1121 of the sharp-tooth mount 112 and each screwing rod 113 has a front end and a sharp tooth 1131. The sharp tooth 1131 is conical, is formed on the front end of the screwing rod 113 and extends out of the front side of the sharp-tooth mount 112. The positioning protrusion 114 is formed on and protrudes from the rear side of the mounting stand 111 between the connecting holes 1112. The embedded slot 115 is circular and is formed in the front side of the mounting stand 111 at the center of the mounting stand 111.

The chunk 12 is cylinder-shaped, is mounted securely on the front side of the base 11 and has a flat rear side, a flat front side, an external surface, an embedded block 121, a guiding face 122, multiple grooves 123, multiple engaging teeth 124, multiple threaded holes 125, multiple through holes 126 and multiple connecting bolts 127.

The flat rear side of the chunk 12 abuts the front side of the mounting stand 111 of the base 11 ahead the sharp teeth 1131 of the screwed rods 113. The exteranl surface is annularly formed around the chunk 12 between the flat sides of the chunk 12. The embedded block 121 is formed on and protrudes from the rear side of the chunk 12 and is mounted in the embedded slot 115 of the base 11 to position the chunk 12 on the base 11. The guiding face 122 is aslantly formed on the external surface of the chunk 12 near the flat front side of the chunk 12. The grooves 123 are formed in the external surface and the guiding face 122 of the chunk 12 at intervals between the flat sides of the chunk 12.

The engaging teeth 124 are formed on the external surface and the guiding face 122 of the chunk 12 between the grooves 123. The threaded holes 125 are formed in the flat rear side of the chunk 12 and respectively align with the bolt-holes 1111 of the mounting stand 111. The through holes 126 are formed through the flat sides of the chunk 12 between the embedded block 121 and the threaded holes 125. The connecting bolts 127 are respectively mounted through the bolt-holes 1111 of the mounting stand 111 and are respectively mounted in the threaded holes 125 of the chunk 12 to connect the chunk 12 securely to the base 11.

The middle colleting device 20 is detachably connected to the rear colleting device 10 and has a base 21 and a chunk 22.

The base 21 is circular, abuts the chunk 12 of the rear colleting device 10 and has a rear side, a front side, a mounting stand 211, a sharp-tooth mount 212, multiple screwing rods 213 and an embedded slot 215. The rear side of the base 21 abuts the flat front side of the chunk 12 of the rear colleting device 10.

The mounting stand 211 is circular, is formed on and protrudes from the front side of the base 21 and has a center, a front side and multiple bolt-holes 2111. The bolt-holes 2111 are formed through the mounting stand 211 at intervals and respectively align with the through holes 126 of the chunk 12 of the rear colleting device 10. The sharp-tooth mount 212 is formed on the front side of the base 21 around the mounting stand 211 and has a front side and multiple screwed holes 2121. The screwed holes 2121 are formed in the front side of the sharp-tooth mount 212 at intervals around the mounting stand 211. The screwing rods 213 are respectively and securely mounted in the screwed holes 2121 of the sharp-tooth mount 212 and each screwing rod 213 has a front end and a sharp tooth 2131. The sharp tooth 2131 is conical, is formed on the front end of the screwing rod 213 and extends out of the front side of the sharp-tooth mount 212. The embedded slot 215 is circular and is formed in the front side of the mounting stand 211 at the center of the mounting stand 211.

The chunk 22 is cylinder-shaped, is mounted securely on the front side of the base 21 and has a flat rear side, a flat front side, an external surface, an embedded block 221, a guiding face 222, multiple grooves 223, multiple engaging teeth 224, multiple threaded holes 225, multiple through holes 226, multiple connecting bolts 227 and a positioning recess 228.

The flat rear side of the chunk 22 abuts the front side of the mounting stand 211 of the base 21 ahead the sharp teeth 2131 of the screwed rods 213. The exteranl surface is annularly formed around the chunk 22 between the flat sides of the chunk 22. The embedded block 221 is formed on and protrudes from the flat rear side of the chunk 22 and is mounted in the embedded slot 215 of the base 21 to position the chunk 22 on the base 21. The guiding face 222 is aslantly formed on the external surface of the chunk 22 near the flat front side of the chunk 22. The grooves 223 are formed in the external surface and the guiding face 222 of the chunk 22 at intervals between the flat sides of the chunk 22.

The engaging teeth 224 are formed on the external surface and the guiding face 222 of the chunk 22 between the grooves 223. The threaded holes 225 are formed in the flat rear side of the chunk 22 and respectively align with the bolt-holes 2111 of the mounting stand 211 and the through holes 126 of the chunk 12 of the rear colleting device 10. The through holes 226 are formed through the flat sides of the chunk 22 between the embedded block 221 and the threaded holes 225. The connecting bolts 227 are respectively mounted through the through holes 126 of the chunk 12 of the rear colleting device 10 and the bolt-holes 2111 of the mounting stand 211 and are respectively mounted in the threaded holes 225 of the chunk 22 to connect the chunk 22 and the base 21 of the middle colleting device 20 securely to the chunk 12 of the rear colleting device 10. The positioning recess 228 is circular and is formed in the flat front side of the chunk 22.

The rear colleting device 30 is detachably connected to the middle colleting device 20 and has a base 31 and a chunk 32.

The base 31 is circular, abuts the chunk 22 of the middle colleting device 20 and has a rear side, a front side, a mounting stand 311, a sharp-tooth mount 312, multiple screwing rods 313, a positioning protrusion 314 and an embedded slot 315. The rear side of the base 31 abuts the flat front side of the chunk 22 of the middle colleting device 20.

The mounting stand 311 is circular, is formed on and protrudes from the front side of the base 31 and has a center, a front side and multiple bolt-holes 3111. The bolt-holes 3111 are formed through the mounting stand 311 at intervals and respectively align with the through holes 226 of the chunk 22 of the middle colleting device 20. The sharp-tooth mount 312 is formed on the front side of the base 31 around the mounting stand 311 and has a front side and multiple screwed holes 3121. The screwed holes 3121 are formed in the front side of the sharp-tooth mount 312 at intervals around the mounting stand 311.

The screwing rods 313 are respectively and securely mounted in the screwed holes 3121 of the sharp-tooth mount 312 and each screwing rod 313 has a front end and a sharp tooth 3131. The sharp tooth 3131 is conical, is formed on the front end of the screwing rod 313 and extends out of the front side of the sharp-tooth mount 312. The positioning protrusion 314 is formed on and protrudes from the rear side of the mounting stand 311 between the bolt-holes 3111 and is mounted in the positioning recess 228 of the chunk 22 of the middle colleting device 20 to position the base 31 on the chunk 22. The embedded slot 315 is circular and is formed in the front side of the mounting stand 311 at the center of the mounting stand 311.

The chunk 32 is cylinder-shaped, is mounted securely on the front side of the base 31 and has a flat rear side, a flat front side, an external surface, an embedded block 321, a guiding face 322, multiple grooves 323, multiple engaging teeth 324, multiple threaded holes 325 and multiple connecting bolts 327.

The flat rear side of the chunk 32 abuts the front side of the mounting stand 311 of the base 31 ahead the sharp teeth 3131 of the screwed rods 313. The exteranl surface is annularly formed around the chunk 32 between the flat sides of the chunk 32. The embedded block 321 is formed on and protrudes from the flat rear side of the chunk 32 and is mounted in the embedded slot 315 of the base 31 to position the chunk 32 on the base 31. The guiding face 322 is aslantly formed on the external surface of the chunk 32 near the flat front side of the chunk 32. The grooves 323 are formed in the external surface and the guiding face 322 of the chunk 32 at intervals between the flat sides of the chunk 32.

The engaging teeth 324 are formed on the external surface and the guiding face 322 of the chunk 32 between the grooves 323. The threaded holes 325 are formed in the flat rear side of the chunk 32 and respectively align with the bolt-holes 3111 of the mounting stand 311 and the through holes 226 of the chunk 22 of the middle colleting device 20. The connecting bolts 327 are respectively mounted through the through holes 226 of the chunk 22 of the middle colleting device 20 and the bolt-holes 3111 of the mounting stand 311 and are respectively mounted in the threaded holes 325 of the chunk 32 to connect the chunk 32 and the base 31 of the front colleting device 30 securely to the chunk 22 of the middle colleting device 20.

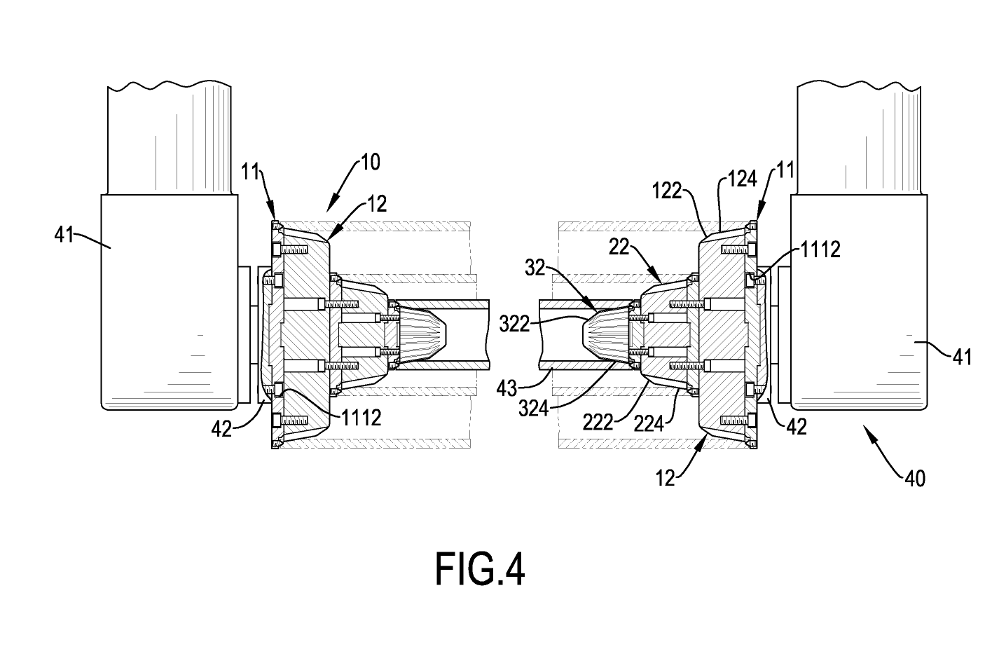

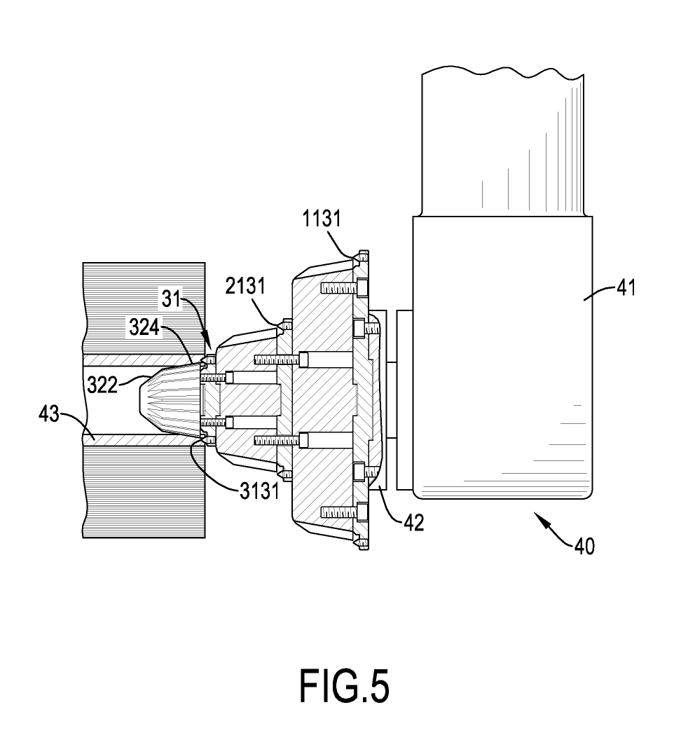

With reference to FIGS. 4 and 5, when the first embodiment of a coil-tube chunk for a roll feeder in accordance with the present invention is used on a roll feeder 40, the roll feeder 40 has a coil tube 43 and two rolling arms 41 set to face each other at an interval to hold the coil tube 43. The coil tube 43 may be a paper tube and has two ends and an internal surface. Each rolling arm 41 has a lower end, an inner side and a driving head 42. The driving head 42 is rotatably mounted on the inner side of the rolling arm 41 at the lower end of the rolling arm 41, is driven by a motor and has an inner end. The base 11 of the rear colleting device 10 is concentrically mounted on the inner end of a corresponding driving head 42 by fasteners mounted between the connecting holes 1112 of the mounting stand 111 and the driving head 42 to hold the coil-tube chunk on the corresponding rolling arm 41.

After mounting the coil-tube chunk on the corresponding rolling arm 41, based on the diameter of the coil tube 43, the chunks 12, 22, 32 are selectively mounted in one of the ends of the coil tube 43 to abut the internal surface of the coil tube 43. With reference to FIG. 5, if the chunk 32 of the front colleting device 30 is mounted in the end of the coil tube 43, the guiding face 322 can provide a guiding effect to enable the chunk 32 to be smoothly mounted in the end of the coil tube 43.

When the chunk 32 is mounted into the corresponding end of the coil tube 43, the engaging teeth 324 engage the internal surface of the coil tube 43, and the sharp teeth 3131 of the screwing rods 313 are inserted into the corresponding end of the coil tube 43. Then, the coil-tube chunk can be securely mounted in and abuts against the corresponding end of the coil tube 43 and this can enable the coil tube 43 to rotate with the driving head 42 via the coil-tube chunk. In addition, the screwing rods 313 are inserted into the corresponding end of the coil tube 43 to hold the coil tube 43 securely with the coil-tube chunk and this can prevent the coil tube 43 from being held open when the thickness of the coil tube 43 is thinning.

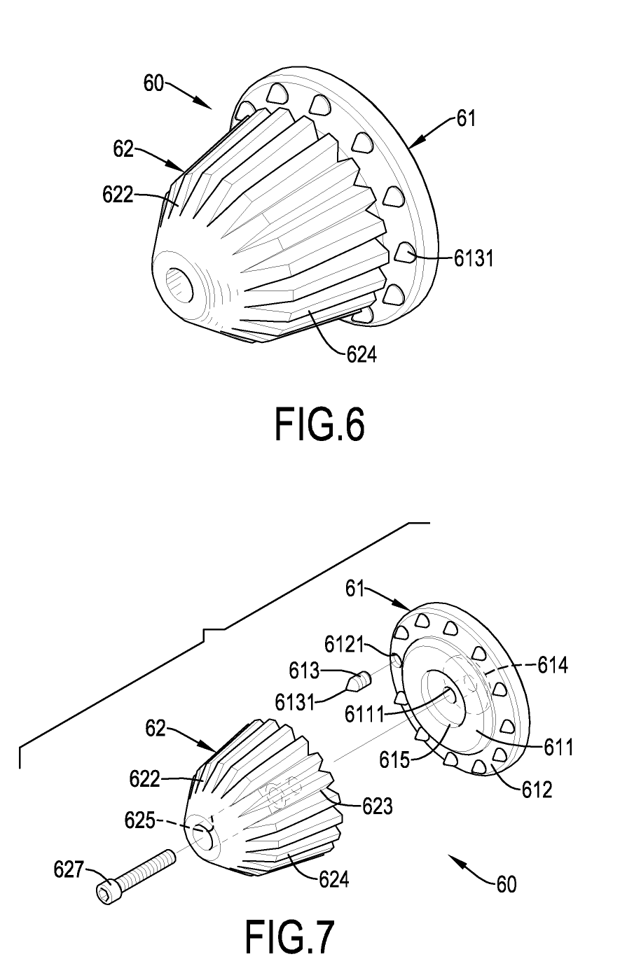

With reference to FIGS. 6, 7, 8A and 8B, a second embodiment of a coil-tube chunk 60 for a roll feeder 70 in accordance with the present invention has a base 61 and a chunk 62.

The base 61 is circular and has a rear side, a front side, a mounting stand 611, a sharp-tooth mount 612, multiple screwing rods 613, a positioning protrusion 614 and an embedded slot 615.

The mounting stand 611 is circular, is formed on and protrudes from the front side of the base 61 and has a center, a front side and a bolt-hole 6111. The bolt-hole 6111 is formed through the center of the mounting stand 611. The sharp-tooth mount 612 is formed on the front side of the base 61 around the mounting stand 611 and has a front side and multiple screwed holes 6121. The screwed holes 6121 are formed in the front side of the sharp-tooth mount 612 at intervals around the mounting stand 611. The screwing rods 613 are respectively and securely mounted in the screwed holes 6121 of the sharp-tooth mount 612 and each screwing rod 613 has a front end and a sharp tooth 6131. The sharp tooth 6131 is conical, is formed on the front end of the screwing rod 613 and extends out of the front side of the sharp-tooth mount 612.

The positioning protrusion 614 is formed on and protrudes from the rear side of the mounting stand 611. The embedded slot 615 is circular and is formed in the front side of the mounting stand 611 at the center of the mounting stand 611 and communicates with the bolt-hole 6111 of the mounting stand 611.

The chunk 62 is cylinder-shaped, is mounted securely on the front side of the base 61 and has a flat rear side, a flat front side, an external surface, an embedded block 621, a guiding face 622, multiple grooves 623, multiple engaging teeth 624, a through hole 625 and a connecting bolt 627.

The flat rear side of the chunk 62 abuts the front side of the mounting stand 611 of the base 61 ahead the sharp teeth 6131 of the screwed rods 613. The exteranl surface is annularly formed around the chunk 62 between the flat sides of the chunk 62. The embedded block 621 is formed on and protrudes from the rear side of the chunk 62 and is mounted in the embedded slot 615 of the base 61 to position the chunk 62 on the base 61. The guiding face 622 is aslantly formed on the external surface of the chunk 62 near the flat front side of the chunk 62. The grooves 623 are formed in the external surface and the guiding face 622 of the chunk 62 at intervals between the flat sides of the chunk 62.

The engaging teeth 624 are formed on the external surface and the guiding face 622 of the chunk 62 between the grooves 623. The through hole 625 is formed through the flat sides of the chunk 62 and aligns with the bolt-hole 6111 of the mounting stand 611 via the embedded slot 615. The connecting bolt 627 is mounted through the through hole 625 of the chunk 62 and the bolt-hole 6111 of the mounting stand 611.

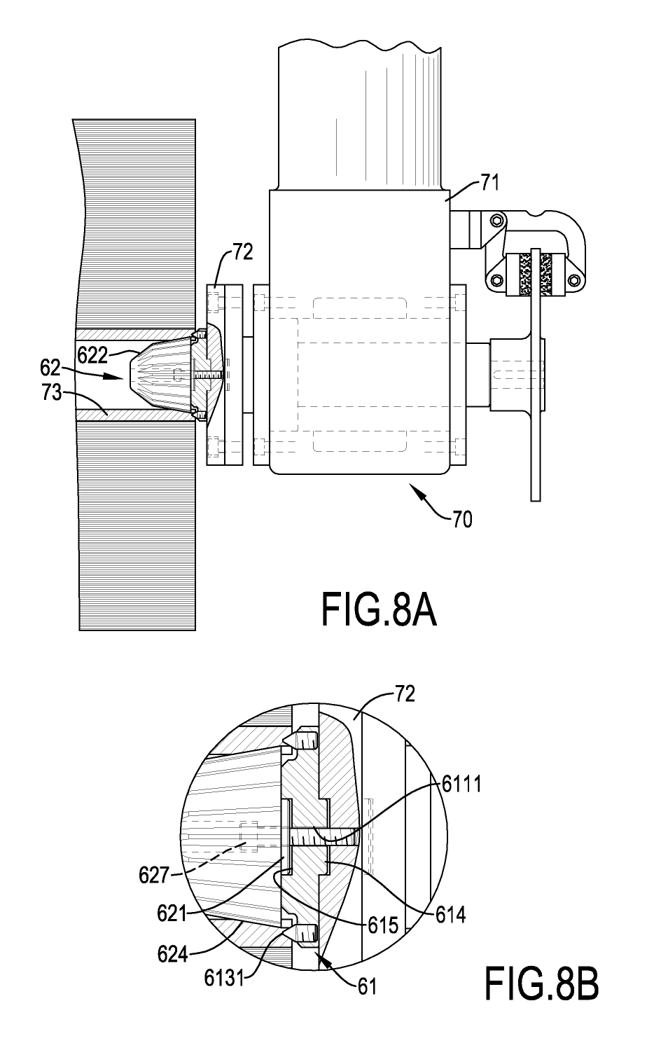

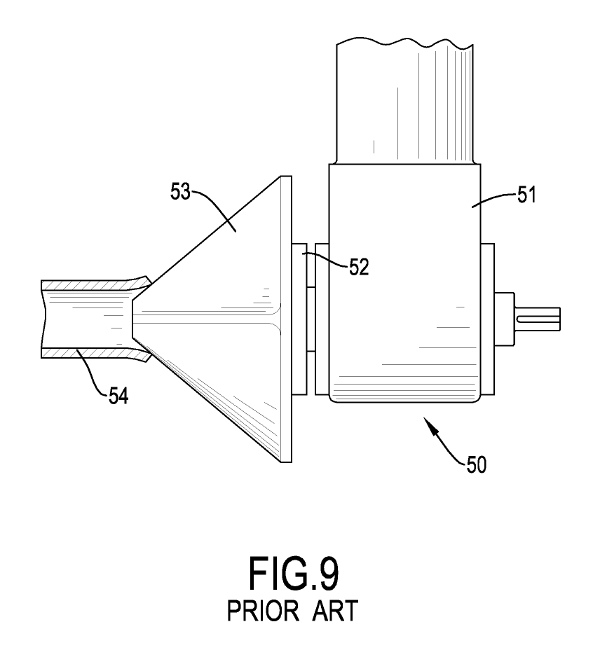

With reference to FIGS. 8A and 8B, when the second embodiment of a coil-tube chunk for a roll feeder in accordance with the present invention is used on a roll feeder 70, the roll feeder 70 has a coil tube 73 and two rolling arms 71 set to face each other at an interval to hold the coil tube 73. The coil tube 73 has two ends and an internal surface. Each rolling arm 71 has a lower end, an inner side and a driving head 72. The driving head 72 is rotatably mounted on the inner side of the rolling arm 71 at the lower end of the rolling arm 71, is driven by a motor and has an inner end. The base 61 of the colleting device 60 is concentrically mounted on the inner end of a corresponding driving head 72 by the connecting bolt 627 securely connected to the corresponding driving head 72 via the through hole 625 of the chunk 62 and the bolt-hole 6111 of the mounting stand 611.

After mounting the colleting device 60 of the coil-tube chunk on the corresponding rolling arm 71, the chunk 62 is mounted in one of the ends of the coil tube 73 to abut the internal surface of the coil tube 73 and the guiding face 622 can provide a guiding effect to enable the chunk 62 to be smoothly mounted in the end of the coil tube 73. When the chunk 62 is mounted into the corresponding end of the coil tube 73, the engaging teeth 624 engage the internal surface of the coil tube 73, and the sharp teeth 6131 of the screwing rods 613 are inserted into the corresponding end of the coil tube 73. Then, the coil-tube chunk can be securely mounted in and abuts against the corresponding end of the coil tube 73 and this can enable the coil tube 73 to rotate with the driving head 72 via the coil-tube chunk. In addition, the screwing rods 613 are inserted into the corresponding end of the coil tube 73 to hold the coil tube 73 securely with the coil-tube chunk and this can prevent the coil tube 43 from being held open when the thickness of the coil tube 73 is thinning.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A coil-tube chunk for a roll feeder comprising
at least one colleting device being adapted to connect to the roll feeder by fasteners and each of the at least one colleting device having
a base being circular and having
a front side;
a mounting stand formed on and protruding from the front side of the base and having
a center;
a front side; and
a rear side;
a sharp-tooth mount formed on the front side of the base around the mounting stand and having
a front side; and
multiple screwed holes formed in the front side of the sharp-tooth mount at intervals around the mounting stand; and
multiple screwing rods respectively and securely mounted in the screwed holes of the sharp-tooth mount and each screwing rod having
a front end; and
a sharp tooth formed on the front end of the screwing rod and extending out of the front side of the sharp-tooth mount; and
a chunk being cylinder-shaped, mounted securely on the front side of the base and having
a flat rear side abutting the front side of the mounting stand of the base;
a flat front side;
an external surface annularly formed around the chunk between the flat sides of the chunk;
a guiding face aslantly formed on the external surface of the chunk near the flat front side of the chunk;
multiple grooves formed in the external surface and the guiding face of the chunk at intervals between the flat sides of the chunk; and
multiple engaging teeth formed on the external surface and the guiding face of the chunk between the grooves.

2. The coil-tube chunk for a roll feeder as claimed in claim 1, wherein
the base of each colleting device has an embedded slot formed in the front side of the mounting stand at the center of the mounting stand; and
the chunk of each colleting device has an embedded block formed on and protruding from the flat rear side of the chunk and mounted in the embedded slot of the base of a corresponding colleting device to position the chunk on the base.

3. The coil-tube chunk for a roll feeder as claimed in claim 2, wherein
the sharp teeth of the screwed rods of the base are conical; and
the flat rear side of the chunk abuts the front side of the mounting stand of the base ahead the sharp teeth of the screwed rods of the corresponding base.

4. The coil-tube chunk for a roll feeder as claimed in claim 3, wherein
the coil-tube chunk has one colleting device;
the base of the colleting device has a bolt-hole formed through the center of the mounting stand; and
the chunk of the colleting device has
a through hole formed through the flat sides of the chunk and aligning with the bolt-hole of the mounting stand via the embedded slot and
a connecting bolt mounted through the through hole of the chunk and the bolt-hole of the mounting stand.

5. The coil-tube chunk for a roll feeder as claimed in claim 4, wherein the base has a positioning protrusion formed on and protruding from the rear side of the mounting stand.

6. The coil-tube chunk for a roll feeder as claimed in claim 3, wherein
the coil-tube chunk has three colleting devices, respectively a rear colleting device, a middle colleting device and a front colleting device and the colleting devices are connected to each other concentrically and the diameters of the colleting devices are in a reducing sequence from the rear colleting device to the front colleting device;
the mounting stand of the base of the rear colleting device has
multiple screwing rods formed through the sides of the mounting stand at intervals; and
a positioning protrusion formed through the sides of the mounting stand at intervals between the bolt-holes and the center of the mounting stand;
the base of the rear colleting device has a positioning protrusion formed on and protruding from the rear side of the mounting stand between the connecting holes of the mounting stand of the base of the rear colleting device;
the chunk of the rear colleting device has
multiple threaded holes formed in the flat rear side of the chunk and respectively aligning with the bolt-holes of the mounting stand of the rear colleting device;
multiple through holes formed through the flat sides of the chunk between the embedded block and the threaded holes; and
multiple connecting bolts respectively mounted through the bolt-holes of the mounting stand of the base of the rear colleting device and respectively mounted in the threaded holes of the chunk to connect the chunk securely to the base of the rear colleting device;
the mounting stand of the base of the middle colleting device has multiple bolt-holes formed through the mounting stand at intervals and respectively aligning with the through holes of the chunk of the rear colleting device;
the chunk of the middle colleting device has
multiple threaded holes formed in the flat rear side of the chunk and respectively aligning with the bolt-holes of the mounting stand of the middle colleting device and the through holes of the chunk of the rear colleting device;
multiple through holes formed through the flat sides of the chunk between the embedded block and the threaded holes of the chunk of the middle colleting device;
multiple connecting bolts respectively mounted through the through holes of the chunk of the rear colleting device and the bolt-holes of the mounting stand of the middle colleting device and respectively mounted in the threaded holes of the chunk of the middle colleting device to connect the chunk and the base of the middle colleting device securely to the chunk of the rear colleting device; and
a positioning recess formed in the flat front side of the chunk of the middle colleting device;
the mounting stand of the base of the front colleting device has multiple bolt-holes formed through the mounting stand at intervals and respectively aligning with the through holes of the chunk of the middle colleting device;
the base of the front colleting device has a positioning protrusion formed on and protruding from the rear side of the mounting stand between the bolt-holes of the front colleting device and mounted in the positioning recess of the chunk of the middle colleting device to position the base of the front colleting device on the chunk of the middle colleting device; and
the chunk of the front colleting device has
multiple threaded holes formed in the flat rear side of the chunk of the front colleting device and respectively aligning with the bolt-holes of the mounting stand of the front colleting device and the through holes of the chunk of the middle colleting device; and
multiple connecting bolts respectively mounted through the through holes of the chunk of the middle colleting device and the bolt-holes of the mounting stand of the front colleting device and respectively mounted in the threaded holes of the chunk of the front colleting device to connect the chunk and the base of the front colleting device securely to the chunk of the middle colleting device.

7. The coil-tube chunk for a roll feeder as claimed in claim 1, wherein
the coil-tube chunk has one colleting device;
the base of the colleting device has a bolt-hole formed through the center of the mounting stand; and
the chunk of the colleting device has
a through hole formed through the flat sides of the chunk and aligning with the bolt-hole of the mounting stand via the embedded slot and
a connecting bolt mounted through the through hole of the chunk and the bolt-hole of mounting stand.

8. The coil-tube chunk for a roll feeder as claimed in claim 2, wherein
the coil-tube chunk has one colleting device;
the base of the colleting device has a bolt-hole formed through the center of the mounting stand; and
the chunk of the colleting device has
a through hole formed through the flat sides of the chunk and aligning with the bolt-hole of the mounting stand via the embedded slot and
a connecting bolt mounted through the through hole of the chunk and the bolt-hole of mounting stand.

9. The coil-tube chunk for a roll feeder as claimed in claim 1, wherein
the coil-tube chunk has three colleting devices, respectively a rear colleting device, a middle colleting device and a front colleting device and the colleting devices are connected to each other concentrically and the diameters of the colleting devices are in a reducing sequence from the rear colleting device to the front colleting device;
the mounting stand of the base of the rear colleting device has
multiple screwing rods formed through the sides of the mounting stand at intervals; and
a positioning protrusion formed through the sides of the mounting stand at intervals between the bolt-holes and the center of the mounting stand;
the base of the rear colleting device has a positioning protrusion formed on and protruding from the rear side of the mounting stand between the connecting holes of the mounting stand of the base of the rear colleting device;
the chunk of the rear colleting device has
multiple threaded holes formed in the flat rear side of the chunk and respectively aligning with the bolt-holes of the mounting stand of the rear colleting device;
multiple through holes formed through the flat sides of the chunk between the embedded block and the threaded holes; and
multiple connecting bolts respectively mounted through the bolt-holes of the mounting stand of the base of the rear colleting device and respectively mounted in the threaded holes of the chunk to connect the chunk securely to the base of the rear colleting device;
the mounting stand of the base of the middle colleting device has multiple bolt-holes formed through the mounting stand at intervals and respectively aligning with the through holes of the chunk of the rear colleting device;
the chunk of the middle colleting device has
multiple threaded holes formed in the flat rear side of the chunk and respectively aligning with the bolt-holes of the mounting stand of the middle colleting device and the through holes of the chunk of the rear colleting device;
multiple through holes formed through the flat sides of the chunk between the embedded block and the threaded holes of the chunk of the middle colleting device;
multiple connecting bolts respectively mounted through the through holes of the chunk of the rear colleting device and the bolt-holes of the mounting stand of the middle colleting device and respectively mounted in the threaded holes of the chunk of the middle colleting device to connect the chunk and the base of the middle colleting device securely to the chunk of the rear colleting device; and
a positioning recess formed in the flat front side of the chunk of the middle colleting device;
the mounting stand of the base of the front colleting device has multiple bolt-holes formed through the mounting stand at intervals and respectively aligning with the through holes of the chunk of the middle colleting device;
the base of the front colleting device has a positioning protrusion formed on and protruding from the rear side of the mounting stand between the bolt-holes of the front colleting device and mounted in the positioning recess of the chunk of the middle colleting device to position the base of the front colleting device on the chunk of the middle colleting device; and
the chunk of the front colleting device has
multiple threaded holes formed in the flat rear side of the chunk of the front colleting device and respectively aligning with the bolt-holes of the mounting stand of the front colleting device and the through holes of the chunk of the middle colleting device; and
multiple connecting bolts respectively mounted through the through holes of the chunk of the middle colleting device and the bolt-holes of the mounting stand of the front colleting device and respectively mounted in the threaded holes of the chunk of the front colleting device to connect the chunk and the base of the front colleting device securely to the chunk of the middle colleting device.

10. The coil-tube chunk for a roll feeder as claimed in claim 2, wherein
the coil-tube chunk has three colleting devices, respectively a rear colleting device, a middle colleting device and a front colleting device and the colleting devices are connected to each other concentrically and the diameters of the colleting devices are in a reducing sequence from the rear colleting device to the front colleting device;
the mounting stand of the base of the rear colleting device has
multiple screwing rods formed through the sides of the mounting stand at intervals; and
a positioning protrusion formed through the sides of the mounting stand at intervals between the bolt-holes and the center of the mounting stand;
the base of the rear colleting device has a positioning protrusion formed on and protruding from the rear side of the mounting stand between the connecting holes of the mounting stand of the base of the rear colleting device;
the chunk of the rear colleting device has
multiple threaded holes formed in the flat rear side of the chunk and respectively aligning with the bolt-holes of the mounting stand of the rear colleting device;
multiple through holes formed through the flat sides of the chunk between the embedded block and the threaded holes; and
multiple connecting bolts respectively mounted through the bolt-holes of the mounting stand of the base of the rear colleting device and respectively mounted in the threaded holes of the chunk to connect the chunk securely to the base of the rear colleting device;
the mounting stand of the base of the middle colleting device has multiple bolt-holes formed through the mounting stand at intervals and respectively aligning with the through holes of the chunk of the rear colleting device;
the chunk of the middle colleting device has
multiple threaded holes formed in the flat rear side of the chunk and respectively aligning with the bolt-holes of the mounting stand of the middle colleting device and the through holes of the chunk of the rear colleting device;
multiple through holes formed through the flat sides of the chunk between the embedded block and the threaded holes of the chunk of the middle colleting device;
multiple connecting bolts respectively mounted through the through holes of the chunk of the rear colleting device and the bolt-holes of the mounting stand of the middle colleting device and respectively mounted in the threaded holes of the chunk of the middle colleting device to connect the chunk and the base of the middle colleting device securely to the chunk of the rear colleting device; and
a positioning recess formed in the flat front side of the chunk of the middle colleting device;
the mounting stand of the base of the front colleting device has multiple bolt-holes formed through the mounting stand at intervals and respectively aligning with the through holes of the chunk of the middle colleting device;
the base of the front colleting device has a positioning protrusion formed on and protruding from the rear side of the mounting stand between the bolt-holes of the front colleting device and mounted in the positioning recess of the chunk of the middle colleting device to position the base of the front colleting device on the chunk of the middle colleting device; and
the chunk of the front colleting device has
multiple threaded holes formed in the flat rear side of the chunk of the front colleting device and respectively aligning with the bolt-holes of the mounting stand of the front collecting device and the through holes of the chunk of the middle colleting device; and
multiple connecting bolts respectively mounted through the through holes of the chunk of the middle colleting device and the bolt-holes of the mounting stand of the front colleting device and respectively mounted in the threaded holes of the chunk of the front colleting device to connect the chunk and the base of the front colleting device securely to the chunk of the middle colleting device.
